(19) United States
(12) Patent Application Publication
(10) Pub. No.: US 2006/0290959 A1
(43) Pub. Date: Dec. 28, 2006

(54) Image processing apparatus and method for controlling image processing apparatus, and program product

(75) Inventors: Mari Kodama, Kanagawa (JP); Ryouichi Satoh, Kanagawa (JP); Yoshiharu Hibi, Kanagawa (JP); Kazuhiko Miura, Kanagawa (JP); Satoshi Yoshikawa, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/473,132

(22) Filed: Jun. 23, 2006

(30) Foreign Application Priority Data
Jun. 24, 2005 (JP) 2005-184646

(51) Int. Cl. H04N 1/60

(52) U.S. Cl. 358/1.9

(57) ABSTRACT

An image processing apparatus for simulating a print output of a printing machine. The image processing apparatus firstly acquires color value information for converting color value information of image data so that a color reproduced on one surface of a recording medium by the printing machine based on the color value information is reproduced as an output. The image processing apparatus secondly acquires show-through color profile information for converting the color value information so that the color reproduced on the one surface by the printing machine as seen from the other surface is reproduced. The image processing apparatus then generates image data formed by composing first image data obtained by converting the color value information based on the color profile information, with second image data obtained by converting the color value information based on the show-through color profile information and by inverting the converted color value information horizontally or vertically.

### BACKGROUND OF THE INVENTION

1. Field of the Invention

The present invention relates to an image processing apparatus, a method for controlling the image processing apparatus, and a program product.

2. Description of the Related Art

In recent years, in the process of generating a color printed matter such as a magazine, state of colors of the final printed matter is sometimes simulated and checked by using an image processing unit such as a printer before printout on a printing machine. In this case, data called a color profile is generated to meet the need of matching the color reproducibility of the printing machine and that of the image processing unit. The color profile is used to match the color reproducibility.

In a recent printing site, it is a common practice to form images on both sides of a relatively thin sheet. In such a case, the printed content on the rear side may be seen through the sheet, a so-called show-through phenomenon. It is a strong need to be able to simulate the state of show-through on the final printed matter by using the above image processing unit. In this case, the state of show-through depends on a sheet or characteristics of a printing machine. There is a strong need to reproduce the influence of show-through on the final printed matter while considering the sheet or characteristic of the printing machine.

The invention has been accomplished in view of the problems, and provides an image processing unit capable of reproducing the state of show-through on a final printed matter as well as improving the accuracy of such reproducibility, a method for controlling the image processing unit, and a program therefor.

### SUMMARY OF THE INVENTION

The invention may provide an image processing apparatus for simulating a print output of a printing machine, wherein the printing machine forms first image on one surface of an image recording medium based on first image data and second image on the other surface of the image recording medium based on second image data. The image processing apparatus may include: a color profile information acquiring unit that acquires color value information for converting color value information on each pixel of image data so that a color reproduced on the one surface by the printing machine based on the color value information is reproduced in an output of the image processing apparatus; a show-through color profile information acquiring unit that acquires show-through color profile information for converting the color value information on each pixel of image data so that the color reproduced on the one surface by the printing machine based on the color value information as seen from the other surface is reproduced in the output of the image processing apparatus; an image generating unit that generates image data formed by composing the first image data with the second image data, the first image data obtained by converting the color value information on each pixel based on the color profile information, the second image data obtained by converting the color value information on each pixel based on the show-through color profile information and inverting the converted color value information horizontally or vertically; and the image output unit that outputs the image data.

The invention may provide a method for controlling an image processing apparatus for simulating print output on a printing machine, wherein the printing machine forms first image on one surface of an image recording medium based on first image data and second image on the other surface of the image recording medium based on second image data. The method may include: acquiring color value information for converting color value information on each pixel of image data so that a color reproduced on the one surface by the printing machine based on the color value information is reproduced in an output of the image processing apparatus; acquiring show-through color profile information for converting the color value information on each pixel of image data so that the color reproduced on the one surface by the printing machine based on the color value information as seen from the other surface is reproduced in the output of the image processing apparatus; generating image data formed by composing the first image data with the second image data, the first image data obtained by converting the color value information on each pixel based on the color profile information, the second image data obtained by converting the color value information on each pixel based on the show-through color profile information and inverting the converted color value information horizontally or vertically; and outputting the image data.

The invention may include a program product for enabling a computer to simulate a print output of a printing machine, wherein the printing machine forms first image on one surface of an image recording medium based on first image data and second image on the other surface of the image recording medium based on second image data. The program product may include: software instructions for enabling the computer to execute predetermined operations; and a computer readable recording medium bearing the software instructions; wherein the predetermined operations includes: acquiring color value information for converting color value information on each pixel of image data so that a color reproduced on the one surface by the printing machine based on the color value information is reproduced in an output of simulation; acquiring show-through color profile information for converting the color value information on each pixel of image data so that the color reproduced on the one surface by the printing machine based on the color value information as seen from the other surface is reproduced in the output of simulation; generating image data formed by composing the first image data with the second image data, the first image data obtained by converting the color value information on each pixel based on the color profile information, the second image data obtained by converting the color value information on each pixel based on the show-through color profile information and inverting the converted color value information horizontally or vertically; and outputting the image data.

### BRIEF DESCRIPTION OF THE DRAWINGS

An embodiment may be described in detail with reference to the accompanying drawings, in which:

FIG. 1 is a block diagram of an image processing unit according to an embodiment of the invention;

FIG. 2 is an explanatory drawing of an example of information defining a color chart;

FIG. 3 is a flowchart of the show-through simulation processing;

FIG. 4 is a drawing that shows an example of a setting screen in the operation mode;

FIG. 5 is an explanatory drawing of an example of show-through simulation; and

FIG. 6 is an explanatory drawing related to generation of a show-through device link profile.

### DETAILED DESCRIPTION OF THE INVENTION

A preferred embodiment of the invention will be detailed below based on drawings.

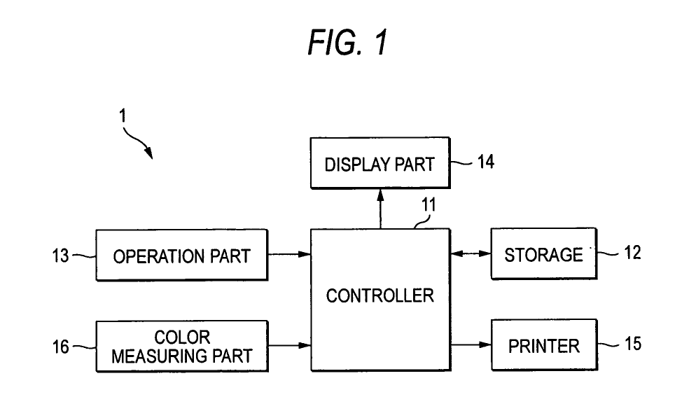

FIG. 1 shows the general configuration of an image processing unit 1 according to this embodiment. The image processing unit 1 includes a controller 11, a storage 12, an operation part 13, a display part 14, a printer 15 and a color measuring part 16.

The controller 11 is implemented by a CPU (Central Processing Unit) and operates in accordance with a program stored in the storage 12. Specific processing made by the controller 11 is detailed later.

The storage 12 may be implemented by a memory element such as a RAM (Random Access Memory) or a ROM (Read Only Memory), or a hard disk. The storage 12 stores a program (software) executed by the controller 11. The program is read from, for example, a computer-readable information storage medium and stored into the storage 12. The storage 12 operates also as a working memory for retaining various data to be used in the course of the processing in the controller 11.

The operation part 13 includes a mouse and a keyboard. The operation part 13 receives input of an instruction from the user and outputs the content of the instruction to the controller 11. The display part 14 is a color display unit or the like and displays an image in accordance with an instruction input from the controller 11.

The printer 15 is a color printer and may be implemented by an output device such as a laser printer and an inkjet printer. The printer 15 forms an image (for example, a color or monochrome print manuscript image including a text, figure, and a photograph) that is based on the image data input from the controller 11 on a sheet-shaped image recording medium such as paper and synthetic resin film for example in accordance with an instruction input from the controller 11.

The color measuring part 16 may be implemented by a scanner unit equipped with a spectrometer. The color measuring part 16 optically scans an image formed on a medium as a target to generate measured color data representing the color of the image and outputs the resulting data to the controller 11 in accordance with an instruction input from the controller 11.

In the image processing unit 1 thus configured, show-through simulation is executed by the controller 11. The show-through simulation is processing to generate and output an image schematically representing show-through. The following describes a case where show-through state at both-side printing on a “printing machine that forms first image data on one surface of a medium and second image data on the other surface of the medium.”

In order to execute show-through simulation, the storage 12 stores a device profile of the image processing unit 1 (printer 15), a profile of a target printing machine (target profile) and a show-through profile (show-through target profile).

The device profile is information that relates the value (for example CMYK value) of a color reproduced in an output from the image processing unit 1 (printer 15) with the value (for example Lab value) of each color in a color space independent of a device.

The target profile is information that relates the value (for example a CMYK value) of a color reproduced on the target printing machine with the value (for example an Lab value) of each color in a color space independent of a device. The target profile is prepared per type of medium used on the target printing machine.

The target profile may be one provided by a manufacturer of the target printing machine.

Alternatively, the target profile may be generated by reading out by the color measuring part 16 a color chart including a plurality of patches (color patches) colored in different colors from each other formed on a medium by the target printing machine.

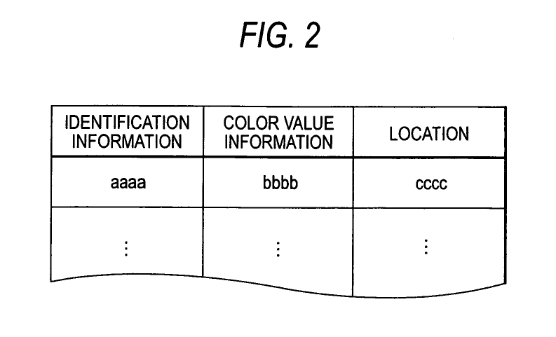

It is assumed that the color and the arrangement of each color patch are predetermined and that identification information uniquely assigned to individual color patches, color value information on color patches, and information representing the locations are stored in an related fashion as a table shown in FIG. 2 in the storage 12. It is also assumed that the color patches are arranged in a matrix with m rows and n columns and information representing the locations of each color patch is set in accordance with the arrangement. That is, it is assumed that, in a color chart formed on a medium, a color patch specified with the color value information is arranged in a location that is based on the information of a location related with the color value information based on the color patch information illustrated in FIG. 2.

The user operates the color measuring part 16 to cause the color patches in the color chart to be read. For example, color patches arranged in m rows by n columns are sequentially read from left to right starting with the top left corner and then left to right in the second row, and so on (hereinafter referred to as the scan line order) until the bottom right corner is reached.

The controller 11 converts the reading results of color patches sequentially input from the color measuring part 16 to values in a color space independent of a device (for example an Lab color space) and sequentially stores the results as target profile information into the storage 12.

The show-through target profile is information that relates the value (for example CMYK value) of a color printed on the rear surface of a medium by the target printing machine and the value (for example Lab value) of a color in a color space independent of a device as seen from the front surface of the medium. The show-through target profile is stored in the storage 12 in association with the target profile. The show-through target profile is also prepared per type of medium used on the target printing machine.

The show-through target profile is generated by causing the color measuring part 16 to read a color chart formed on a medium by the target printing machine from the rear side (from the surface opposite to the surface where the color chart as a target) via the medium.

The user operates the color measuring part 16 to turn over the medium where the color chart is formed by the target printing machine and causes the color patches in the color chart to be read in a predetermined order from the rear side via the medium. For example, the user causes the color patches arranged in m rows by n columns to be sequentially read starting with the top right corner to the bottom left corner in the scan line order.

The controller 11 converts the reading results of color patches sequentially input from the color measuring part 16 to values in a color space independent of a device and sequentially stores the results as show-through target profile information into the storage 12. That is, the show-through target profile information serves as a conversion table for converting the color value information on each original color patch (for example information in a CMYK color space consisting of cyan C, magenta M, yellow Y and black K) to the value of a color independent of a device (value in the Lab color space) as seen from the front surface via the medium when the color in the color value information is printed on the rear surface of the medium.

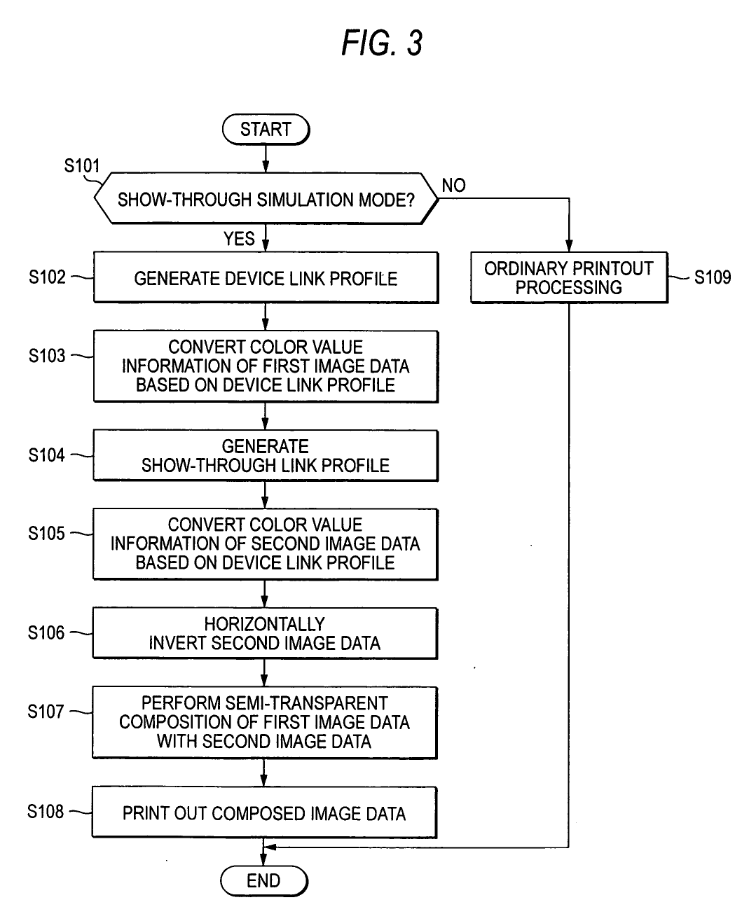

The controller 11 accepts input of data of an image to be formed on the front surface of the medium (called first image data) and data of an image to be formed on the rear surface of the medium (called second image data) from the user and performs processing shown in FIG. 3.

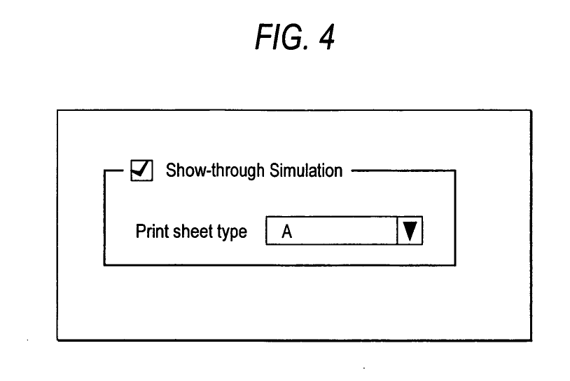

As shown in FIG. 3, the controller 11 determines whether the operation mode of the image processing unit 1 is show-through simulation mode (S101). The operation mode is set on a setting screen show in FIG. 4. The setting screen is displayed on the display part 14 for example as part of a print instruction screen. The user determines on the setting screen whether to use the show-through simulation mode and the type of print sheet.

In case the operation mode is not the show-through simulation mode, the controller 11 performs ordinary printout processing (S109). For example, the controller 11 instructs the printer 15 to form the first image data and the second image data on separate media. Or, for example, the controller 11 instructs the printer 15 to form the first image data on the front surface of a medium and the second image data on the rear surface of the medium.

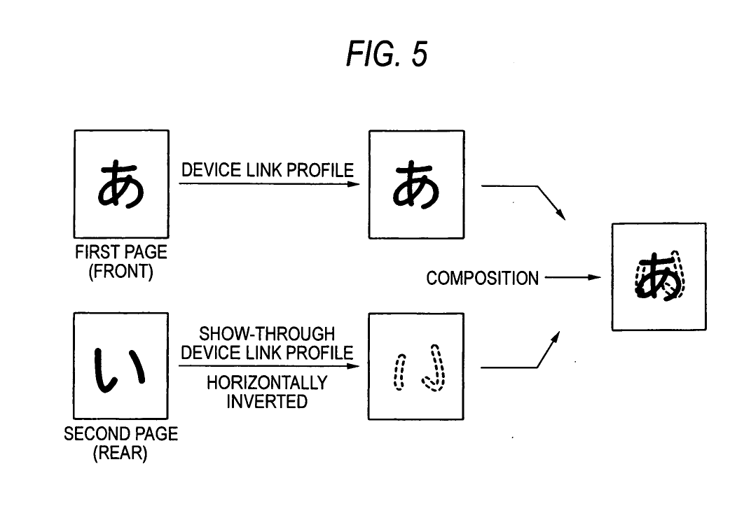

In case the operation mode is the show-through simulation mode, the controller 11 performs the processing from steps S102 through S106 to perform show-through simulation (FIG. 5).

The controller 11 generates a device link profile corresponding to the type of the specified print sheet (S102). That is, the controller 11 uses a device profile and a target profile corresponding to the type of a specified print sheet to generate a device link profile (color profile information) where CMYK values related with Lab values common to the two profile information items are related with each other.

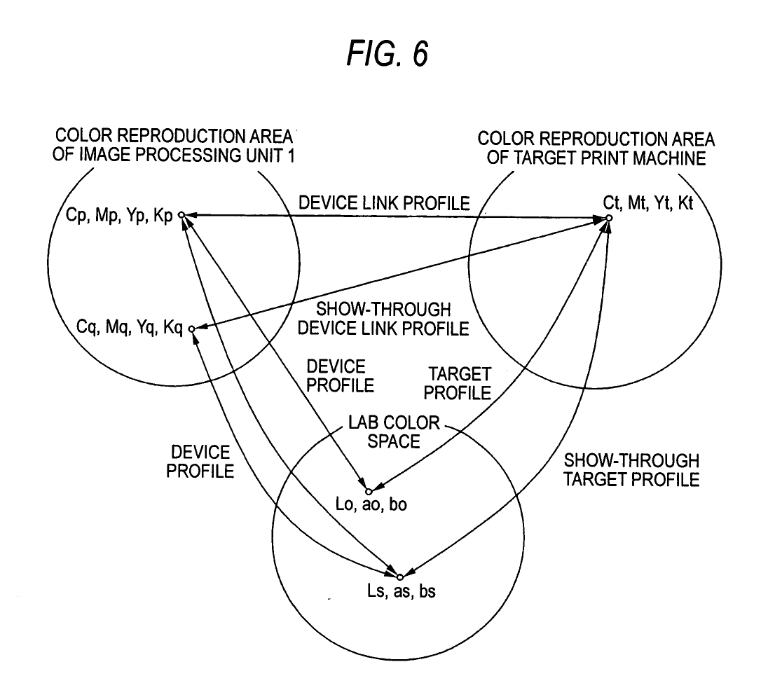

For example, as shown in FIG. 6, when the target printing machine has output specific CMYK values (Ct, Mt, Yt, Kt) in the target profile, assume that the Lab values of the color are Lo, ao, bo. Also assume that the CMYK values of the image processing unit 1 corresponding to Lo, ao, bo are Cp, Mp, Yp, Kp from the device profile.

In order to simulate the result of the colors of Ct, Mt, Yt, Kt to be output on the target printing machine, it suffices to output on the image processing unit 1 the colors of Cp, Mp, Yp, Kp. The conversion table used to perform this conversion is determined by the device link profile.

In other words, the device link profile is information that relates the value (CMYK value) of a color to be reproduced on the image processing unit 1 (printer 15) with the value (CMYK value) of a color to be accordingly reproduced on the target printing machine.

Next, the controller 11 converts the color value information on each pixel of the first image data to a CMYK value. The controller 11 then uses a device link profile generated in step S102 to convert the output of a target printing machine that is based on the CMYK value to a CMYK value to be simulated on the image processing unit 1 (S103).

Next, the controller 11 generates a show-through device link profile corresponding to the type of a specified print sheet (S104). In other words, the controller 11 uses a device profile and a show-through target profile corresponding to the type of a specified print sheet to generate a show-through device link profile (show-through color profile information) that relates the CMYK values related with Lab values common to the two profile information items with each other.

For example, as shown in FIG. 6, when the target printing machine has output specific CMYK values (Ct, Mt, Yt, Kt) in the show-through target profile, assume that the Lab values of the show-through color are Ls, as, bs. Also assume that the CMYK values of the image processing unit 1 corresponding to Ls, as, bs are Cq, Mq, Yq, Kq from the device profile.

In order to simulate the show-through result of the colors of Ct, Mt, Yt, Kt to be output on the target printing machine, it suffices to output on the image processing unit 1 the colors of Cq, Mq, Yq, Kq. The conversion table used to perform this conversion is determined by the show-through device link profile.

In other words, the show-through device link profile is information that relates the value (CMYK value) of a color printed on the rear surface of a medium on a target printing machine with the value (CMYK value) of a color to be reproduced on the image processing unit 1 as seen from the front surface of the medium.

Next, the controller 11 converts the color value information of the second image data to a CMYK value. The controller 11 then uses a show-through device link profile generated in step S104 to convert the output of a target printing machine that is based on the CMYK value to a CMYK value to be simulated on the image processing unit 1 (S105). The controller 11 then horizontally inverts the second image data (S106).

The controller 11 converts these color values and performs semi-transparent composition of the horizontally inverted second image data with the color-value-converted first image data (S107). The semi-transparent composition refers to addition of values of corresponding pixels in the first image data and the second image data. The controller 11 (image generating means) outputs the image data obtained as the result of semi-transparent composition to the printer 15 (image output means) (S108).

The controller 11 may perform the following processing as well as the processing in step S102 through S108.

The controller 11 may convert the color value information on each pixel of the second image data to a CMYK value. The controller 11 may use a device link profile generated in step S102 to convert the output of a target printing machine that is based on the CMYK value to a CMYK value to be simulated on the image processing unit 1.

The controller 11 may convert the color value information on each pixel of the first image data to a CMYK value. The controller 11 may use a show-through device link profile generated in step S104 to convert the output of a target printing machine that is based on the CMYK value to a CMYK value to be simulated on the image processing unit 1. Further, the controller 11 may horizontally invert the first image data.

The controller 11 (image generating means) may convert these color values and perform semi-transparent composition of the horizontally inverted first image data with the color-value-converted second image data, and output the obtained image data to the printer 15 (image output means). In this case, the generated image data and the image data generated in step S108 may be formed on separate media or on both surfaces of a single medium.

According to the image processing unit 1 described above, it is possible to simulate the state of show-through on a real printing machine. In particular, the image processing unit 1 performs such simulation by using a show-through device link profile representing the color reproducibility of show-through on the real printing machine. This improves the reproduction accuracy of show-through on the final printed matter (print output of the real printing machine).

The invention is not limited to the foregoing embodiments.

For example, depending on the specifications of both-side printing of a target printing machine, vertical inversion may be performed instead of horizontal inversion in step S106 or the like.

For example, the storage 12 may store a device profile that relates the value (for example, CMYK value) of a color reproduced by the output from the display part 14 with the value (for example, Lab value) of each color in a color space independent of a device. In steps S102 or S104, a device link profile or a show-through device link profile may be generated based on the device profile. In step S108 or the like, image data obtained as a result of semi-transparent composition may be output to the display part 14 (image output means).

For example, a device link profile and a show-through device link profile may be generated in advance and stored in the storage 12. In this case, processing in steps S102 and S104 may be omitted in the processing shown in FIG. 3. It is thus made possible to perform the processing in steps S103 and S105 based on the device link profile or the show-through device link profile read from the storage 12.

For example, in step S108, composition of the color-value-converted, horizontally inverted second image data with the color-value-converted first image data may be executed by composition processing other than semi-transparent composition. For example, the color-value-converted first image data may be superposed on the color-value-converted, horizontally inverted second image data.

For example, a show-through target profile may be generated as described below.

The controller 11 generates the image data of a color chart where the color patches of colors specified in the color value information are arranged in locations that are based on the location information related with the color value information, based on the color patch information illustrated in FIG. 2. The controller 11 outputs the image data of the color chart thus generated to the printer 15 to form the color chart on a medium. The color chart formed is hereinafter referred to as a device chart.

The user operates the color measuring part 16 to cause the color patches in the device chart to be read in predetermined order. For example, color patches arranged in m rows by n columns are sequentially read in the scan line order from the top left corner to the bottom right corner.

The controller 11 converts the reading results of color patches sequentially input from the color measuring part 16 to values in a color space independent of a device (for example an Lab color space) and sequentially stores the results as device profile information into the storage 12. The device profile information is information associating a color value (for example CMYK value) reproduced by the image processing unit 1 (printer 15) with a value (for example Lab value) of each color in a color space independent of a device.

The user operates the color measuring part 16 to turn over the medium where the device chart is formed by the target printing machine and causes the color patches in the color chart to be read in a predetermined order from the rear side via the medium. For example, the user causes the color patches arranged in m rows by n columns to be sequentially read starting with the top right corner to the bottom left corner in the scan line order.

The controller 11 thus converts the reading results of color patches sequentially input from the color measuring part 16 to values in a color space independent of a device and sequentially stores the results as show-through device profile information into the storage 12. That is, the show-through device profile information serves as a conversion table for converting the color value information on each original color patch (for example information in a CMYK color space consisting of cyan C, magenta M, yellow Y and black K) to the value of a color independent of a device (value in the Lab color space) as seen from the front surface via the medium when the color in the color value information is printed on the rear surface of the medium.

The controller 11 uses device profile information and a target profile of a target print machine to generate device link information that relates the CMYK values related to the Lab values common in these two profile information.

The controller 11 uses the device link profile and the show-through device profile information to generate information that relates the value (CMYK value) of a color reproduced on a target print machine with the value (value in the Lab color space) of show-through.

For example, assume that the Lab values obtained when color patches of Cp, Mp, Yp, Kp formed on the rear surface of a medium by the image processing unit 1 are read from the front surface of a medium via the medium are Ls, as, bs. In case the colors Cp, Mp, Yp, Kp of the image processing unit 1 are defined to correspond to the colors Ct, Mt, Yt, Kt on the target print machine, it is possible to assume that the show-through colors obtained when the colors Ct, Mt, Yt, Kt are output on a target print machine are Ls, as, bs. A show-through target profile related to the target print machine may be generated in this way.

While the image processing unit 1 includes the printer 15 in the foregoing description, the printer 15 may be a separate unit from the image processing unit 1. In other words, the image processing unit 1 may be a so-called printer server or a computer system that outputs a print instruction to the printer.

The entire disclosure of Japanese Patent Application No. 2005-184646 filed on Jun. 24, 2005 including specification, claims, drawings and abstract is incorporated herein by reference in its entirety.

What is claimed is:

1. An image processing apparatus for simulating a print output of a printing machine, wherein the printing machine forms first image on one surface of an image recording medium based on first image data and second image on the other surface of the image recording medium based on second image data, the image processing apparatus comprising:
a color profile information acquiring unit that acquires color value information for converting color value information on each pixel of image data so that a color reproduced on the one surface by the printing machine based on the color value information is reproduced in an output of the image processing apparatus;
a show-through color profile information acquiring unit that acquires show-through color profile information for converting the color value information on each pixel of image data so that the color reproduced on the one surface by the printing machine based on the color value information as seen from the other surface is reproduced in the output of the image processing apparatus;
an image generating unit that generates image data formed by composing the first image data with the second image data, the first image data obtained by converting the color value information on each pixel based on the color profile information, the second image data obtained by converting the color value information on each pixel based on the show-through color profile information and inverting the converted color value information horizontally or vertically; and
the image output unit that outputs the image data.

2. The image processing apparatus according to claim 1,
wherein the image generating unit generates image data formed by composing the second image data with the first image data, the second image data obtained by converting the color value information on each pixel based on the color profile information, the first image data obtained by converting the color value information on each pixel based on the show-through color profile information and inverting the converted color value information horizontally or vertically.

3. A method for controlling an image processing apparatus for simulating print output on a printing machine, wherein the printing machine forms first image on one surface of an image recording medium based on first image data and second image on the other surface of the image recording medium based on second image data, the method comprising:
acquiring color value information for converting color value information on each pixel of image data so that a color reproduced on the one surface by the printing machine based on the color value information is reproduced in an output of the image processing apparatus;
acquiring show-through color profile information for converting the color value information on each pixel of image data so that the color reproduced on the one surface by the printing machine based on the color value information as seen from the other surface is reproduced in the output of the image processing apparatus;
generating image data formed by composing the first image data with the second image data, the first image data obtained by converting the color value information on each pixel based on the color profile information, the second image data obtained by converting the color value information on each pixel based on the show-through color profile information and inverting the converted color value information horizontally or vertically; and
outputting the image data.

4. A program product for enabling a computer to simulate a print output of a printing machine, wherein the printing machine forms first image on one surface of an image recording medium based on first image data and second image on the other surface of the image recording medium based on second image data, the program product comprising:
software instructions for enabling the computer to execute predetermined operations; and
a computer readable recording medium bearing the software instructions;
wherein the predetermined operations includes:
acquiring color value information for converting color value information on each pixel of image data so that a color reproduced on the one surface by the printing machine based on the color value information is reproduced in an output of simulation;
acquiring show-through color profile information for converting the color value information on each pixel of image data so that the color reproduced on the one surface by the printing machine based on the color value information as seen from the other surface is reproduced in the output of simulation;
generating image data formed by composing the first image data with the second image data, the first image data obtained by converting the color value information on each pixel based on the color profile information, the second image data obtained by converting the color value information on each pixel based on the show-through color profile information and inverting the converted color value information horizontally or vertically; and
outputting the image data.
